(19) United States
(12) Patent Application Publication
(10) Pub. No.: US 2025/0381757 A1
(43) Pub. Date: Dec. 18, 2025

(54) LOCALIZED GLASS FILTER

(71) Applicant: Volvo Car Corporation, Gothenburg (SE)

(72) Inventor: Hans Sixten Jartoft, Götaland (SE)

(21) Appl. No.: 18/745,619

(22) Filed: Jun. 17, 2024

(51) Int. Cl. B32B 7/02; B32B 1/00; B32B 17/10; B60J 1/00; B60J 1/02

(52) U.S. Cl. CPC B32B 7/02; B32B 1/00; B32B 17/10036; B32B 17/10165; B32B 17/10816; B60J 1/001; B60J 1/02; B32B 2605/00

(57) ABSTRACT

A window system having a variety of optical properties is described. To adjust a property (e.g., physical, optical, etc.) of a window, a piece of material can be placed at the location of the desired property, wherein the piece of material has the desired property. The desired property can be a tint, polarization, opaque to a particular portion of the electromagnetic spectrum, and such. Accordingly, a window can be fabricated having a range of properties across one or more regions of the window. The piece of material can have a thickness enabling the piece of material to be deformable. The piece of material can have an initial curved profile such that only a first part of the piece of material initially touches a surface of the windscreen. During application of the piece of material, the material deforms to match the surface profile of the window.

### TECHNICAL FIELD

This application relates to utilizing a glass piece to adjust optical/physical properties of a section of a pane of automotive glass.

### BACKGROUND

Use of cameras and sensors have become commonplace to assist an operator of a vehicle, e.g., rearward facing cameras and sensors to assist a driver reverse into a parking spot, forward facing cameras for lane assist and object detection, and the like. However, for reasons of aesthetics, optics, sensing requirements, and the like, implementation of the cameras, etc., may require the automotive glass to be fabricated with differing optical/physical properties across the glass pane. For example, if the light transmission in a first area/portion of the glass is to be controlled compared with a second area of the glass, multiple layers of glass may have to be combined/laminated during manufacture of the plane of glass, as it is not possible for the multiple properties to be achieved with a single layer of glass. However, fabrication of a pane of automotive glass with differing optical/physical properties across the pane can be a complex endeavor, potentially to the point of being impossible and/or prohibitively expensive, depending upon the type of glass, glass design, etc.

### SUMMARY

The following presents a summary to provide a basic understanding of one or more embodiments described herein. This summary is not intended to identify key or critical elements, or delineate any scope of the different embodiments and/or any scope of the claims. The sole purpose of the Summary is to present some concepts in a simplified form as a prelude to the more detailed description presented herein.

In one or more embodiments described herein, systems, methods, apparatus and/or computer program products are presented regarding fabrication and implementation of an automotive glass having a range of desired properties.

As further described, one or more layers of material can be applied to the automotive glass, whereby the one or more layers of material have the desired property. The one or more embodiments described herein present an automotive glass, comprising a layer of first material, wherein the layer of first material has a first profile having a first curvature. The automotive component can further comprise a layer of second material located on the first material, wherein, prior to application of the second material to the first material, the second material has a second profile having a second curvature, the first curvature is shallower than the second curvature, and upon completion of location of the second material on the first material, the layer of second material has a third profile having a third curvature, the third curvature matches, or substantially matches, the first curvature of the first profile.

In an embodiment, the layer of first material forms one of a windshield, a windscreen, a rear window, a rear windshield, a side window, a quarter glass/window, a door window, a sun roof, a moon roof, a roof window, transparent roof, a rear-view mirror, a sun visor mirror, a side view mirror, a cover of a console, or a cover of an infotainment system.

In another embodiment, the layer of second material provides a property to the automotive component, wherein the property is not present with the layer of first material, the property is one of an optical property, a thermal property, a tint, a physical property, or an electromagnetic property.

In an embodiment, the first material is at least one of a glass, an acrylic, a polymer, a polycarbonate, a polyurethane, a polymethyl methacrylate, a transparent material, a material having a desired optical property, a material transparent to visible light, a material opaque to visible light, a material semi-opaque to visible light, or any combination of the foregoing materials. Further, the second material is at least one of a glass, an acrylic, a polymer, a polycarbonate, a polyurethane, a polymethyl methacrylate, a transparent material, a material having a desired optical property, a material transparent to visible light, a material opaque to visible light, a material semi-opaque to visible light, or any combination of the foregoing materials.

In another embodiment, the automotive component can further comprise a structure configured to locate a device, and position the layer of second material relative to the layer of first material.

In an embodiment, the device can be a sensor or a camera configured to transmit or receive eletromagnetic radiation through the automotive component at a location of the layer of second material on the layer of first material.

In a further embodiment, the automotive component can further comprise a layer of third material located between the layer of first material and the layer of second material, wherein the third material is an adhesive configured to adhere the layer of second material to the layer of first material.

In an embodiment, the layer of second material can be located on an interior surface of the layer of the first material.

In a further embodiment, during initial location of the layer of second material on the layer of first material, a first region of the layer of the second material touches the layer of first material, and upon completion of location of the layer of second material on the layer of first material, the first region of the layer of second material and a second region of the layer of second material follow the first curvature of the first profile, wherein the first region of the layer of the second material is located at, or substantially at, a center of the layer of the second material and the second region of the layer of the second material is located at, or substantially at, an edge of the layer of the second material.

In other embodiments, elements described in connection with the disclosed systems can be embodied in different forms such as a method. For example, in an embodiment, a method can be utilized to fabricate an automotive component, wherein the method comprises positioning a second material on a first material, wherein a first profile of the first material has a first curvature and a second profile of the second material has a second curvature which is greater than the first curvature, wherein, during positioning, a first point on the second material touches the first material prior to a second point on the second material. The method can further comprise applying pressure to the second material, deforming the second material such that the second material deforms to a third profile, wherein the third profile has a third curvature, the third curvature is similar to the first curvature, facilitating adherence of the second material to the first material.

According to further embodiments, an automotive glass component is provided, comprising (a) a first layer of first material having a first profile with a first curvature, and (b) a second layer of second material located on the first layer of first material, wherein, prior to application of the second material to the first material, the second material has a second profile having a second curvature, the first curvature is shallower than the second curvature, and upon completion of location of the second material on the first material, the layer of second material has a third profile having a third curvature, the third curvature matches, or substantially matches, the first curvature of the first profile.

In an embodiment, a first area of first layer of first material covered by the second layer of second material is limited to a region required for operation of the at least one of a sensor or a camera, and a second area of the first layer of material has an optical property facilitating transmission of visible light through the first layer of first material.

### DESCRIPTION OF THE DRAWINGS

One or more embodiments are described below in the Detailed Description section with reference to the following drawings.

FIG. 1 presents a schematic illustrating a vehicle windshield having a multi-layered structure, in accordance with one or more embodiments.

FIGS. 2A-2C present schematics illustrating a multi-layered structure and fabrication of the structure, in accordance with one or more embodiments.

FIG. 3 presents a schematic illustrating a multi-layered structure, in accordance with one or more embodiments.

FIG. 4 presents a schematic illustrating a configuration of a second material prior to application onto a first material, in accordance with one or more embodiments.

FIG. 5 presents a schematic illustrating a structure being utilized to locate a second material on a first material, in accordance with an embodiment.

FIG. 6 presents a schematic illustrating a structure being utilized to locate a second material on a first material, in accordance with an embodiment.

FIG. 7 is a flowchart presenting a method for locating a first material on a second material, in accordance with one or more embodiments.

FIG. 8 is a flowchart presenting a method for locating a second material on a first material, in accordance with one or more embodiments.

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, Abstract section, and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting. Further, ranges A-n are utilized herein to indicate a respective plurality of devices, components, signals etc., where n is any positive integer.

The various embodiments presented herein disclose various systems, structures, operations, etc., regarding fabrication of a window, or suchlike, for automotive use. To address issues regarding utilizing a windscreen, or suchlike, having a variety of properties across the windscreen, a piece/layer of material of smaller area than the windscreen can be attached to a surface of the windscreen, wherein the smaller piece of material can have a thickness rendering the piece of material to be deformable and hence takes the shape/profile of the windscreen. Further, the piece of material can have one or more properties (e.g., a tint, a filter for polarizing light passing therethrough, transparency, opaqueness, and such) as required for limited application on the windscreen. For example, the piece of material can be tinted to visibly hide a camera located behind the windscreen. The one or more properties may be not present/unavailable for a particular region of the windscreen, and can be added with the piece/layer of material. Multiple pieces of material can be applied/stacked to enable regions of the windscreen to have a variety of properties, e.g., optical properties, thermal properties, and such. In an embodiment, the piece of material can be applied to a windscreen, etc., during fabrication/manufacture of a windscreen, vehicle, etc. In another embodiment, the piece of material can be applied to a windscreen, etc., of an existing/aftermarket vehicle, e.g., during retrofitting of a sensor to the vehicle. In another embodiment, a sensor may be an option to a vehicle configuration/package, with the sensor and piece of material added at the time of purchase of the vehicle.

In another embodiment, where two or more devices are attached to a window (e.g., a rear window) and the respective devices require differing optical properties, a first piece of material having a first optical property can be positioned on the window proximate to the location of the first device (e.g., a visible light sensing camera requiring polarized light) and a second piece of material having a second optical property can be positioned on the window proximate to the location of the second device (e.g., an infrared sensor), such that first piece of material and the second piece of material render the window to have three difference optical properties (e.g., first optical property of the window, second optical property of the first piece of material, third optical property of the second piece of material, and suchlike). Accordingly, a window can be created having different material/optical properties, wherein the multi-property window may be impossible or expensive to fabricate using conventional/existing glass making technology and/or materials.

It is to be appreciated that while the various embodiments presented herein are presented with regard to a glass, and suchlike, located on a vehicle, the presented embodiments are not so limited and can be applied to any situation where a glass, or similar material, requires a confined implementation of one or more properties, as utilized in any vehicle/system such as military equipment, marine equipment, railroad equipment, aviation equipment, manned spaceflight, and the like, as well as any application of glass utilized for transmission/reception of electromagnetic radiation.

### 1. Automotive Component Having a Layered Structure

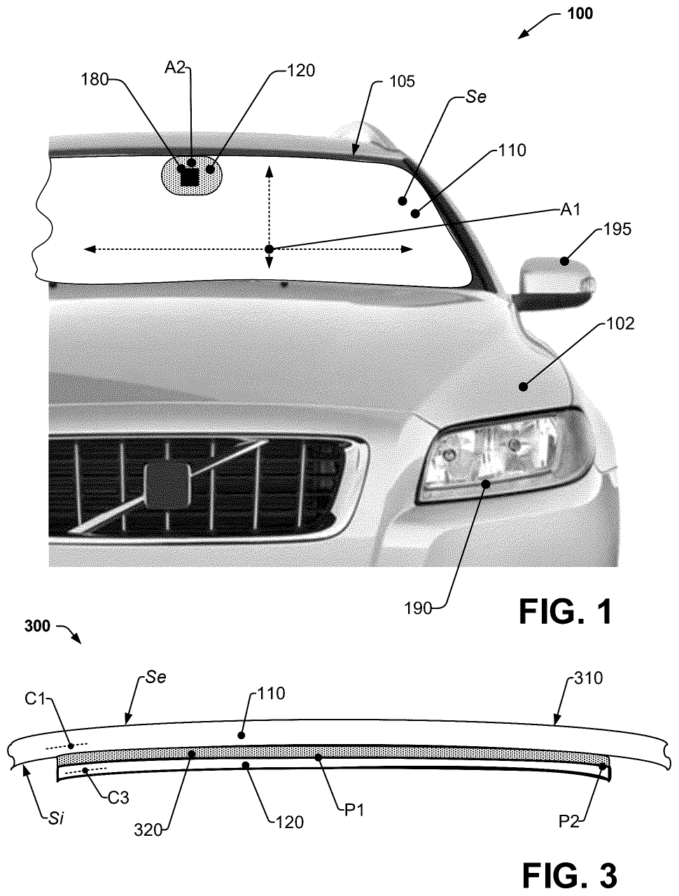

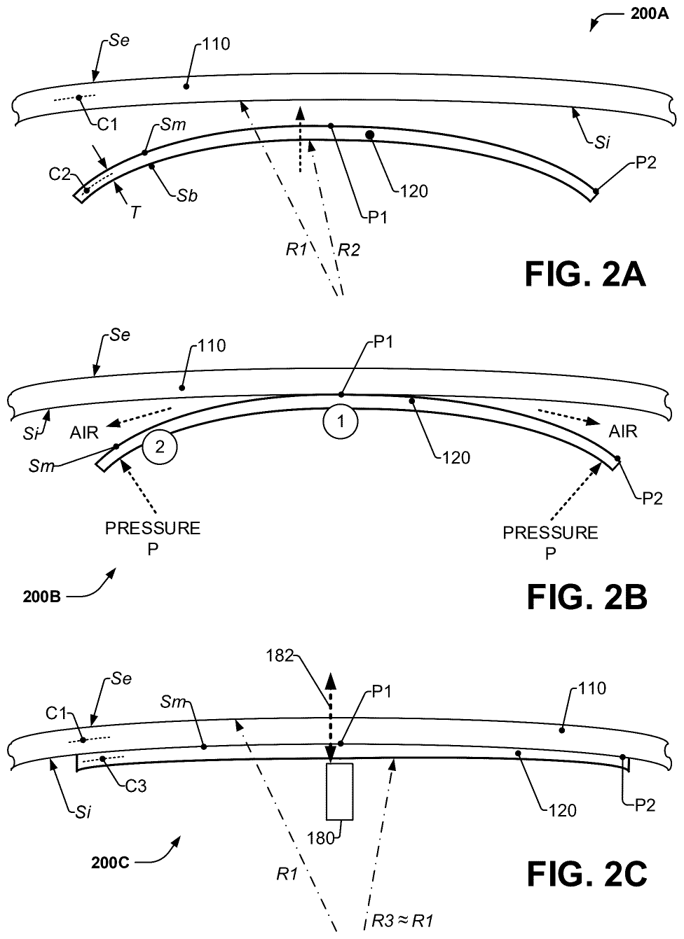

Turning now to the drawings, FIG. 1, schematic 100, illustrates a vehicle windshield having a multi-layered structure, in accordance with one or more embodiments. As shown, a windshield 105 is located onboard a vehicle 102. Windshield 105 can be fabricated with a first material 110 and a second material 120. In an example embodiment of application, first material 110 can be a glass designed for use as an automotive glass, having an exterior surface Se and an interior surface Si (e.g., per FIGS. 2A-C). Windshield 105 can be positioned onboard vehicle 102 such that the interior surface Si forms an interior surface to a passenger compartment of vehicle 102. As shown in FIG. 1, windshield 105 has a first area, A1, while second material 120 covers a second area, A2, whereby second area A2 is an area/region of a smaller overall dimension than the first area, A1. Accordingly, the region (e.g., area A2) covered by the second material 120 limits application of a material property (e.g., second property) of the second material 120 to a region/area A2. For example, the second material 120 has a material property (e.g., a masking tint to visibly hide a camera 180) not present/unavailable/expensive to produce with fabrication of the windshield 105, and with a sensor or camera 180 located behind/interior side of second material 120, the second property provided by the second material 120 is limited to region A2, while the remainder of windshield 105 has a first property (e.g., material transparency to enable a driver to visually navigate vehicle 102).

While not shown, one or more portions/regions of the layer of second material 120 can be printed with non-see through black ink/paint. Further, layer of second material 120 positioned on the interior, e.g., surface Sb, can be treated (e.g., roughened, have a bonding agent/adhesive, and such) to enable a component (e.g., device 180) to be attached to the interior surface of the layer of second material 120. In an example of use, a front windshield 110 requires glass/material with a higher transparency/clarity than can be used for a rear window, side windows, sun roof, a moon roof, a roof window, a transparent roof, etc., hence, the layer of second material 120 can provide localized tinting of the windshield 110 that legally cannot be applied to the whole surface of the windshield 110.

FIGS. 2A-2C present various illustrations 200A-200C of a multi-layered structure and fabrication of the structure, in accordance with one or more embodiments. As shown in FIG. 2A, a second material 120 is being positioned relative to a first material 110. In an embodiment, the first material 110 can form an object such as a window for an automotive application, wherein the second material can be a windshield, a windscreen, a rear window, a rear windshield, a side window, a quarter glass/window, a door window, a sun roof, a moon roof, a roof window, a transparent roof, a rear-view mirror glass/material, a sun visor mirror glass/material, side view mirror glass/material, glass covering/in a console, glass covering/in an infotainment system, and suchlike. First material 110 can be a single sheet/pane of material or a laminate comprising multiple sheets/layers.

First material 110 and second material 120 can be fabricated from any suitable material, such as glass, acrylic, polymer, polycarbonate, polyurethane, polymethyl methacrylate, a transparent material, a material having a desired optical property, a thermal property, coloration, a tint, a material transparent to visible light, a material opaque to visible light, a material semi-opaque to visible light, any combination of the foregoing materials, and such.

Thickness T of the second material 120 can be such that the second material 120 can be deformed. For example, second material 120 can be fabricated from glass, and while glass is considered a brittle/rigid material, thickness T can be of a dimension such that the second material 120 can be deformed from a first shape/profile to a second shape/profile. First material 110, when used, for example, as a rear window, can be fabricated with tempered glass, while when used, for example, as a front window, can be fabricated from a laminated glass (e.g., comprising layers of glass and vinyl).

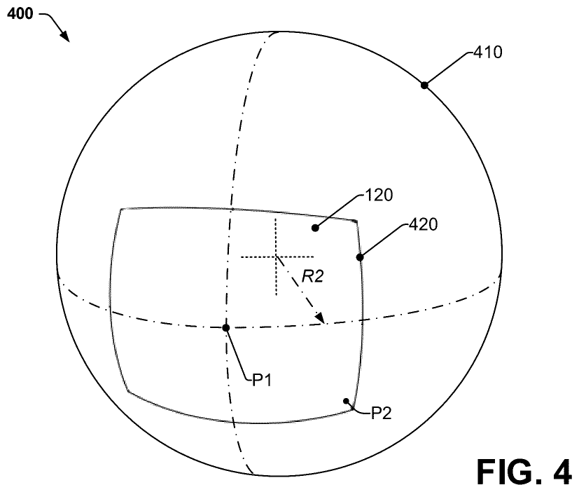

First material 110 can be a shape fabricated with first profile having an initial first curvature C1 and the second material 120 can be fabricated/shaped/formed with a second curvature C2, wherein the first curvature C1 is shallower than the second curvature C2 (R1>R2, per FIG. 4). As shown in FIG. 2B, owing to the initial curvature C2 of the second material 120, during initial placement of the second material 120 on the first material 110, only a first point P1 of the second material 120 contacts/touches a first surface of the first material 110, while second point P2 is currently not incident upon the first material 110. P1 can be located at or near a center of the second material 120 and P2 can be located at, or near, the edge (e.g., edge 420, per FIG. 4) of the second material 120.

As shown in FIGS. 2B and 2C, pressure P can be applied to the second material 120 to facilitate engagement/location of the second material 120 on the first material 110, e.g., both first point P1 and second point P2 are located on the surface Si of the first material 110. Second material 120 can include a mating surface, Sm, which can locate against surface Si of the first material. In an embodiment, pressure P can be applied initially at the location of the first point P1 of the second material 120 on the surface Si of the first material 110, with subsequent application/final application of the pressure P extending out from the first point P1 such that any air/gas at the interface of the surface Si of the first material 110 and mating surface Sm of the second material 120 is expelled, thereby preventing entrapment of air between the first material 110 and the second material 120 to avoid formation of air bubbles between the interfacing surfaces Si and Sm of the first material 110 and the second material 120. Air bubbles can be unsightly, aesthetically displeasing, and further affect operation of a device (e.g., a sensor, a camera, and such) placed behind the second material 120. As shown in FIG. 2C, upon completion of application of the second material 120 on the first material 110, the second material 120 has deformed such that the second material 120 has a third curvature C3, wherein C3 has a curvature the same, or substantially similar to, curvature C1, with the final shaped profile of second material 120 following the contour of surface Si of first material 110. Expressing the respective curvatures with radius of curvature Ra-n, curvature C1 has a greater radius of curvature R1 than the radius of curvature R2 of curvature C2, while curvatures C1 and C3 are the same, or substantially the same, such that radius R3≈R1.

As mentioned, a device 180, such as a sensor, a camera, and such, can be positioned at the rear of the second material 120, e.g., on an interior of the vehicle. Device 180 can be configured to transmit/receive radiation/energy 182 at any part of the electromagnetic spectrum, such as visible light, infrared light, ultraviolet light, and such. Accordingly, both first material 110 and second material 120 can be transparent regarding transmission/reception of the electromagnetic energy 182. In an example application, the first material 110 can be a windshield fabricated from glass enabling viewing of the operating environment of the vehicle 102 while the second material 120 can comprise of a glass that, while still transparent, is darker (e.g., tinted) than the glass material of the first material 110. Hence, when the vehicle is viewed from the outside, the second material 120 visibly hides the device 180 located behind the first material 110.

While not shown, multiple layers (e.g., multiple layers of second material 120 respectively having a different property) can be stacked/layered on top of each other to achieve a final property across the stacked layers, wherein the final property is a combination of the respective property of each respective layer.

FIG. 3, schematic 300, illustrates a multi-layered structure 310, in accordance with one or more embodiments. Structure 310 is similar to structures 100 and 200A-C, however a third material 320 is layered between the first material 110 and the second material 120, wherein the third material 320 can be an adhesive configured to attach/adhere the first material 110 to the second material 120. Per the foregoing, third material 320 can have the same desired property as the second material 120, for example, third material 320 can be a transparent material to facilitate transmission/reception of electromagnetic energy 182 through structure 310, comparable to transmission/reception of electromagnetic energy 182 through structure(s) represented in FIGS. 1 and 2A-C.

FIG. 4, schematic 400, illustrates a configuration of a second material prior to application onto a first material, in accordance with one or more embodiments. As shown, the piece of second material 120 can have a profile represented by a sphere 410, wherein sphere 410 has a radius of curvature R2. With the piece of second material 120 having a rectangular shape, when point P1 of second material 120 is positioned on the shallower curvature R1 of first material 110, point P2 (e.g., located at, or substantially close to, edge 420 of piece of second material 120) stands proud/away from surface Si, per FIG. 1. While second material 120 is presented in FIG. 4 as having a uniform, spherical surface, the various embodiments are not so limited, and any profile can be utilized, e.g., flat at a central portion with a curved profiled extending out edge(s) 420.

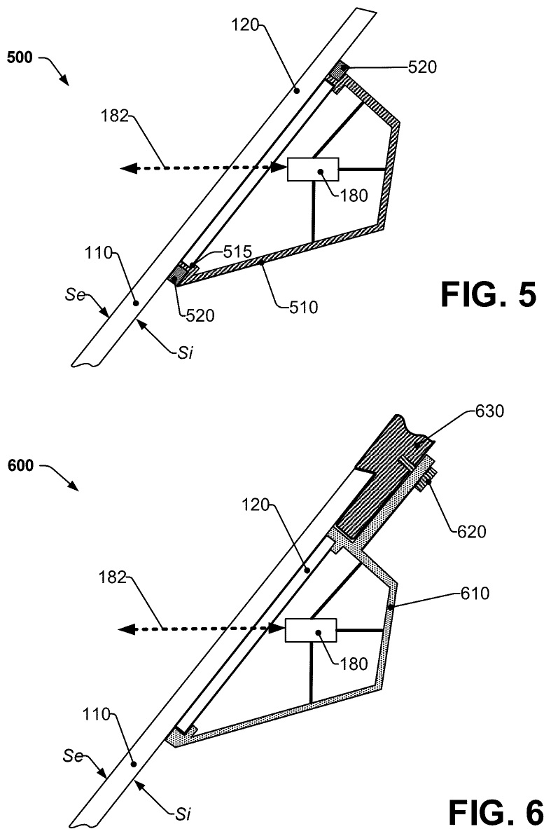

FIG. 5, schematic 500, illustrates a structure being utilized to locate a second material on a first material, in accordance with an embodiment. As shown in FIG. 5, a structure/housing 510 is presented, wherein the structure 510 can be a structure fabricated to house/locate/position the device 180. As further shown, a fourth material 520 can be located between the structure 510 and the interior/inner surface Si of the second material 120. The fourth material 520 can be an adhesive configured to adhere structure 510 to the first material 110, e.g., to position device 180. Structure 510 can be configured to support the second material 120 (e.g., in a recessed lip 515), such that with the structure 510 located on/adhered to inner surface Si, the second material 120 is located against surface Si. As previously described, second material 120 can be fabricated from a flexible, rigid, or semi-rigid, substance and initially has a curved profile C2. As structure 510 is located on the surface Si, the second material 120 is deformed such that with structure 510 located on surface Si, the second material 120 has a subsequent/final profile C3 that matches, or substantially matches, the profile/curvature C1 of surface Si of the first material 110.

FIG. 6, schematic 600, illustrates a structure being utilized to locate a second material on a first material, in accordance with an embodiment. As shown in FIG. 6, a structure/housing 610 is presented, wherein the structure 610 can be a structure fabricated to house/locate/position the device 180. Structure 610 can have functionality comparable to structure 510 regarding locating the second material 120 on first material 110, however, rather than being adhered to first material 110, structure 610 can be located/fixed on a surface of the vehicle (e.g., an interior surface/structure 630), wherein such location can be by one or more suitable mechanical fastener(s) 620 such as screw, a nut and bolt, and the like. Structure 610 can be configured to support the second material 120, such that with the structure 610 positioned and located on inner surface Si, the second material 120 is also located against surface Si. As previously described, second material 120 can be fabricated from a flexible substance and initially has a curved profile C2. As structure 610 is located on the surface Si, the second material 120 is deformed such that with a portion of structure 610 located on surface Si, the second material 120 has a subsequent profile C3 that matches, or substantially matches, the profile/curvature C1 of surface Si of the first material 110.

Structures 510 and 610 can be fabricated from any suitable material, e.g., a metal, aluminum, a polymer, a composite, combination of the foregoing, and suchlike.

It is to be appreciated that while the foregoing describes a configuration where the second material 120 is located on an interior surface Si of first material 110 (e.g., the second material 120 is located on a passenger compartment side of a vehicle 102, and surface Se of the first material 110 forms an exterior surface of the vehicle 102), the various embodiments are not so limited, and the second material 120 can be placed on the exterior surface Se formed by the first material 110 located on the vehicle 102.

It is to also be appreciated that while the various embodiments presented herein relate to a first material 110 being fabricated to form a windshield 105, the various embodiments are not so limited and can be equally applied to a material component located anywhere on the vehicle 102, wherein the component can be a cover, a glass covering a vehicle light 190 (e.g., any of a headlight, rear light, brake light, etc.), glass in a wing mirror 195, and the like.

### 2. Methods of Fabrication

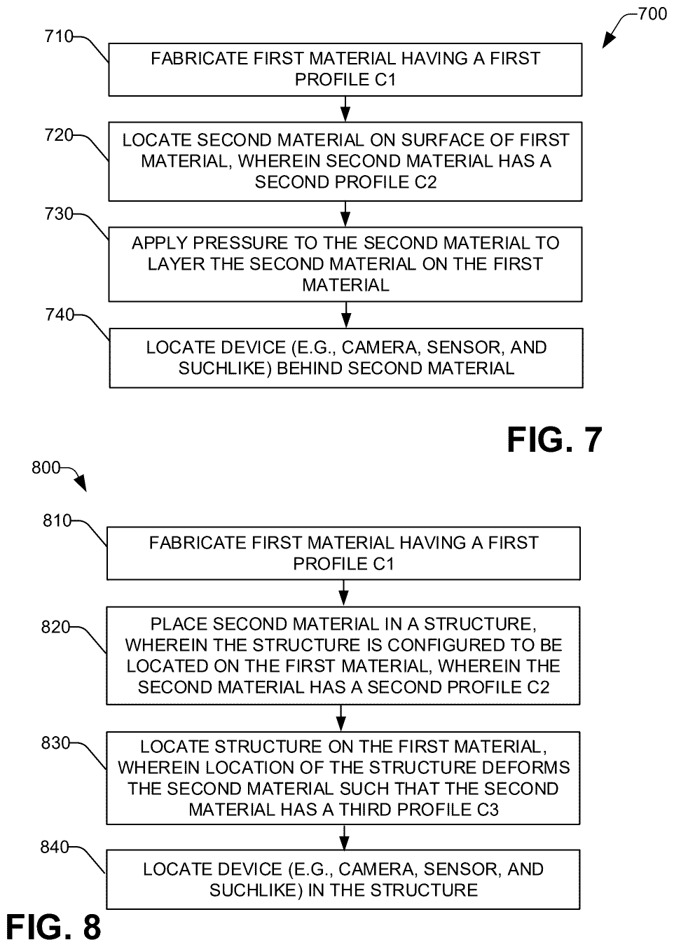

FIG. 7, via flowchart 700, presents a method for locating a first material on a second material, in accordance with one or more embodiments.

At 710, a first material (e.g., first material 110) can be fabricated, wherein the first material has a first shape profile C1. The first shape profile can be flat, having a first curvature, or combination of both.

At 720, a second material (e.g., second material 120) can be located against the first material (e.g., first material 110), wherein the second material has a second shape profile C2. The second shape profile C2 can have a second curvature, wherein the first shape profile C1 has a curvature less than the curvature of the second profile C2. The second material can be initially placed against a surface (e.g., surface Si) the first material such that only a first region/point (e.g., point P1) of the second material is touching the first material, e.g., as a function of the difference in curvature of the first curvature C1 and the second curvature C2.

At 730, pressure can be applied to the second material to facilitate deformation of the second material to cause the second material to have a third shape profile C3, wherein the third shape profile C3 is the same, or substantially the same, as the first shape profile C1. As previously mentioned, application of the pressure P can be controlled such that the pressure is applied outwards from the first region P1 to second region P2 of the second material positioned proximate to the first material, e.g., to prevent air entrapment/bubble formation between the first material and the second material.

At 740, a device (e.g., device 180) can be positioned behind the second material, enabling transmission/reception of electromagnetic energy (e.g., energy 182) through the first material and the second material.

It is to be appreciated that while the respective steps presented in FIG. 7 describe location of the second material on the first material, the embodiments are not so limited, and a third material (e.g., third material 320) can be located/sandwiched between the first material and the second material, wherein the third material can be an adhesive material configured to adhere the second material to the first material.

FIG. 8, via flowchart 800, illustrates a method for locating a second material on a first material, in accordance with one or more embodiments.

At 810, a first material (e.g., first material 110) can be fabricated, wherein the first material has a first shape profile C1. The first shape profile can be flat or having a first curvature.

At 820, a second material (e.g., second material 120) can be located in a structure (e.g., structure 510 or structure 610), wherein the structure can be configured to house a device (e.g., device 180) configured to transmit/receive electromagnetic radiation (e.g., energy 182). Second material can have a second shape profile C2.

At 830, the structure can be positioned such that a surface (e.g., surface Sm) of the second material locates against a surface (e.g., surface Si) of the first material. During location of the structure at/proximate to the surface of the first material, the second material can undergo deformation such that, with the structure located against the first material, the second material has a shape profile C3 matching the shaped profile of the surface (e.g., surface Si) against which the second material is located. As a function of placing the structure against the first material, with the second material constrained (e.g., by recess 515) by the structure, pressure P is applied to the second material, causing the second material to flatten with the shape profile C3 such that respective regions (e.g., points P1 and P2) are located on the surface of the first material.

At 840, a device (e.g., device 180) can be positioned in the structure. The second material is located between the device and the first material, the device is positioned/operated to enable transmission/reception of electromagnetic energy (e.g., energy 182) through the first material and the second material.

Per the foregoing, multiple structures/methods are available when utilizing a structure (e.g., structure 510, structure 610) to locate the second material 120 onto the first material 110, such as utilizing any combination of a recessed lip (e.g., recess 515), an adhesive (e.g., adhesive 520), a structure configured with/utilizes a fastener (e.g., fastener 620), and suchlike.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Various non-limiting aspects of various embodiments described herein are presented in the following clauses.

Clause 1. An automotive component, comprising: a layer of first material, wherein the layer of first material has a first profile having a first curvature; and a layer of second material located on the first material, wherein, prior to application of the second material to the first material, the second material has a second profile having a second curvature, the first curvature is shallower than the second curvature, and upon completion of location of the second material on the first material, the layer of second material has a third profile having a third curvature, the third curvature matches, or substantially matches, the first curvature of the first profile.

Clause 2. The automotive component of any preceding clause, wherein the layer of first material forms one of a windshield, a windscreen, a rear window, a rear windshield, a side window, a quarter glass/window, a door window, a sun roof, a moon roof, a roof window, a transparent roof, a rear-view mirror, a sun visor mirror, a side view mirror, a cover of a console, or a cover of an infotainment system.

Clause 3. The automotive component of any preceding clause, wherein the layer of second material provides a property to the automotive component, wherein the property is not present with the layer of first material, the property is one of an optical property, a thermal property, a tint, a physical property, or an electromagnetic property.

Clause 4. The automotive component of any preceding clause, wherein: the first material is at least one of a glass, an acrylic, a polymer, a polycarbonate, a polyurethane, a polymethyl methacrylate, a transparent material, a material having a desired optical property, a material transparent to visible light, a material opaque to visible light, a material semi-opaque to visible light, or any combination of the foregoing materials; and the second material is at least one of a glass, an acrylic, a polymer, a polycarbonate, a polyurethane, a polymethyl methacrylate, a transparent material, a material having a desired optical property, a material transparent to visible light, a material opaque to visible light, a material semi-opaque to visible light, or any combination of the foregoing materials.

Clause 5. The automotive component of any preceding clause, further comprising: a structure configured to: locate a device; and position the layer of second material relative to the layer of first material.

Clause 6. The automotive component of any preceding clause, wherein the device is a sensor or a camera configured to transmit or receive eletromagnetic radiation through the automotive component at a location of the layer of second material on the layer of first material.

Clause 7. The automotive component of any preceding clause, further comprising a layer of third material located between the layer of first material and the layer of second material, wherein the third material is an adhesive configured to adhere the layer of second material to the layer of first material.

Clause 8. The automotive component of any preceding clause, wherein the layer of second material is located on an interior surface of the layer of the first material.

Clause 9. The automotive component of any preceding clause, wherein during initial location of the layer of second material on the layer of first material, a first region of the layer of the second material touches the layer of first material, and upon completion of location of the layer of second material on the layer of first material, the first region of the layer of second material and a second region of the layer of second material follow the first curvature of the first profile, wherein the first region of the layer of the second material is located at, or substantially at, a center of the layer of the second material and the second region of the layer of the second material is located at, or substantially at, an edge of the layer of the second material.

Clause 10. A method for fabricating an automotive component, comprising: positioning a second material on a first material, wherein a first profile of the first material has a first curvature and a second profile of the second material has a second curvature which is greater than the first curvature, wherein, during positioning, a first point on the second material touches the first material prior to a second point on the second material; and applying pressure to the second material, deforming the second material such that the second material deforms to a third profile, wherein the third profile has a third curvature, the third curvature is similar to the first curvature, facilitating adherence of the second material to the first material.

Clause 11. The method of fabricating the automotive component of any preceding clause, wherein: the first material is at least one of a glass, an acrylic, a polymer, a polycarbonate, a polyurethane, a polymethyl methacrylate, a transparent material, a material having a desired optical property, a material transparent to visible light, a material opaque to visible light, a material semi-opaque to visible light, or any combination of the foregoing materials; and the second material is at least one of a glass, an acrylic, a polymer, a polycarbonate, a polyurethane, a polymethyl methacrylate, a transparent material, a material having a desired optical property, a material transparent to visible light, a material opaque to visible light, a material semi-opaque to visible light, or any combination of the foregoing materials.

Clause 12. The method of fabricating the automotive component of any preceding clause, wherein the first material is a window located onboard a vehicle.

Clause 13. The method of fabricating the automotive component of any preceding clause, wherein the window has an interior surface and an exterior surface, and the second material is located on the interior surface.

Clause 14. The method of fabricating the automotive component of any preceding clause, wherein the second material has a property not present with the first material.

Clause 15. The method of fabricating the automotive component of any preceding clause, wherein the property is one of an optical property, a thermal property, a tint, a physical property, or an electromagnetic energy transmission property.

Clause 16. The method of fabricating the automotive component of any preceding clause, further comprising locating a sensor, such that the second material is placed between the first material and the sensor, and the property of the second material facilitates operation of the sensor.

Clause 17. An automotive glass component comprising: a first layer of first material having a first profile with a first curvature; and a second layer of second material located on the first layer of first material, wherein, prior to application of the second material to the first material, the second material has a second profile having a second curvature, the first curvature is shallower than the second curvature, and upon completion of location of the second material on the first material, the layer of second material has a third profile having a third curvature, the third curvature matches, or substantially matches, the first curvature of the first profile.

Clause 18. The automotive glass component of any preceding clause, wherein the layer of first material forms one of a windshield, a windscreen, a rear window, a rear windshield, a side window, a quarter glass/window, a door window, a sun roof, a moon roof, a roof window, a transparent roof, a rear-view mirror, a sun visor mirror, a side view mirror, a cover of a console, or a cover of an infotainment system, and the second layer of second material has a property not present with the first material.

Clause 19. The automotive glass component of any preceding clause, wherein the second layer of second material is located between the first layer of first material and at least one of a sensor or a camera, wherein the second layer has a property not present with the layer of first material, and the property is required for operation of the at least one of a sensor or a camera.

Clause 20. The automotive glass component of any preceding clause, wherein a first area of first layer of first material covered by the second layer of second material is limited to a region required for operation of the at least one of a sensor or a camera, and a second area of the first layer of material has an optical property facilitating transmission of visible light through the first layer of first material.

In various cases, any suitable combination of clauses 1-9 can be implemented.

In various cases, any suitable combination of clauses 10-16 can be implemented.

In various cases, any suitable combination of clauses 17-20 can be implemented.

What is claimed is:

1. An automotive component, comprising:
a layer of first material, wherein the layer of first material has a first profile having a first curvature; and
a layer of second material located on the first material, wherein, prior to application of the second material to the first material, the second material has a second profile having a second curvature, the first curvature is shallower than the second curvature, and upon completion of location of the second material on the first material, the layer of second material has a third profile having a third curvature, the third curvature matches, or substantially matches, the first curvature of the first profile.

2. The automotive component of claim 1, wherein the layer of first material forms one of a windshield, a windscreen, a rear window, a rear windshield, a side window, a quarter glass/window, a door window, a sun roof, a moon roof, a roof window, a transparent roof, a rear-view mirror, a sun visor mirror, a side view mirror, a cover of a console, or a cover of an infotainment system.

3. The automotive component of claim 1, wherein the layer of second material provides a property to the automotive component, wherein the property is not present with the layer of first material, the property is one of an optical property, a thermal property, a tint, a physical property, or an electromagnetic property.

4. The automotive component of claim 1, wherein:
the first material is at least one of a glass, an acrylic, a polymer, a polycarbonate, a polyurethane, a polymethyl methacrylate, a transparent material, a material having a desired optical property, a material transparent to visible light, a material opaque to visible light, a material semi-opaque to visible light, or any combination of the foregoing materials; and
the second material is at least one of a glass, an acrylic, a polymer, a polycarbonate, a polyurethane, a polymethyl methacrylate, a transparent material, a material having a desired optical property, a material transparent to visible light, a material opaque to visible light, a material semi-opaque to visible light, or any combination of the foregoing materials.

5. The automotive component of claim 1, further comprising:
a structure configured to:
locate a device; and
position the layer of second material relative to the layer of first material.

6. The automotive component of claim 5, wherein the device is a sensor or a camera configured to transmit or receive eletromagnetic radiation through the automotive component at a location of the layer of second material on the layer of first material.

7. The automotive component of claim 1, further comprising a layer of third material located between the layer of first material and the layer of second material, wherein the third material is an adhesive configured to adhere the layer of second material to the layer of first material.

8. The automotive component of claim 1, wherein the layer of second material is located on an interior surface of the layer of the first material.

9. The automotive component of claim 1, wherein during initial location of the layer of second material on the layer of first material, a first region of the layer of the second material touches the layer of first material, and upon completion of location of the layer of second material on the layer of first material, the first region of the layer of second material and a second region of the layer of second material follow the first curvature of the first profile, wherein the first region of the layer of the second material is located at, or substantially at, a center of the layer of the second material and the second region of the layer of the second material is located at, or substantially at, an edge of the layer of the second material.

10. A method for fabricating an automotive component, comprising:
positioning a second material on a first material, wherein a first profile of the first material has a first curvature and a second profile of the second material has a second curvature which is greater than the first curvature, wherein, during positioning, a first point on the second material touches the first material prior to a second point on the second material; and
applying pressure to the second material, deforming the second material such that the second material deforms to a third profile, wherein the third profile has a third curvature, the third curvature is similar to the first curvature, facilitating adherence of the second material to the first material.

11. The method of fabricating the automotive component of claim 10, wherein:
the first material is at least one of a glass, an acrylic, a polymer, a polycarbonate, a polyurethane, a polymethyl methacrylate, a transparent material, a material having a desired optical property, a material transparent to visible light, a material opaque to visible light, a material semi-opaque to visible light, or any combination of the foregoing materials; and
the second material is at least one of a glass, an acrylic, a polymer, a polycarbonate, a polyurethane, a polymethyl methacrylate, a transparent material, a material having a desired optical property, a material transparent to visible light, a material opaque to visible light, a material semi-opaque to visible light, or any combination of the foregoing materials.

12. The method of fabricating the automotive component of claim 10, wherein the first material is a window located onboard a vehicle.

13. The method of fabricating the automotive component of claim 12, wherein the window has an interior surface and an exterior surface, and the second material is located on the interior surface.

14. The method of fabricating the automotive component of claim 12, wherein the second material has a property not present with the first material.

15. The method of fabricating the automotive component of claim 14, wherein the property is one of an optical property, a thermal property, a tint, a physical property, or an electromagnetic energy transmission property.

16. The method of fabricating the automotive component of claim 15, further comprising locating a sensor, such that the second material is placed between the first material and the sensor, and the property of the second material facilitates operation of the sensor.

17. An automotive glass component comprising:
a first layer of first material having a first profile with a first curvature; and
a second layer of second material located on the first layer of first material, wherein, prior to application of the second material to the first material, the second material has a second profile having a second curvature, the first curvature is shallower than the second curvature, and upon completion of location of the second material on the first material, the layer of second material has a third profile having a third curvature, the third curvature matches, or substantially matches, the first curvature of the first profile.

18. The automotive glass component of claim 17, wherein the layer of first material forms one of a windshield, a windscreen, a rear window, a rear windshield, a side window, a quarter glass/window, a door window, a sun roof, a moon roof, a roof window, a transparent roof, a rear-view mirror, a sun visor mirror, a side view mirror, a cover of a console, or a cover of an infotainment system, and the second layer of second material has a property not present with the first material.

19. The automotive glass component of claim 18, wherein the second layer of second material is located between the first layer of first material and at least one of a sensor or a camera, wherein the second layer has a property not present with the layer of first material, and the property is required for operation of the at least one of a sensor or a camera.

20. The automotive glass component of claim 18, wherein a first area of first layer of first material covered by the second layer of second material is limited to a region required for operation of the at least one of a sensor or a camera, and a second area of the first layer of material has an optical property facilitating transmission of visible light through the first layer of first material.
